(19) United States
(12) Patent Application Publication
(10) Pub. No.: US 2003/0230452 A1
(43) Pub. Date: Dec. 18, 2003

(54) Ladder with tape holder

(75) Inventors: Paul Campagna, Canton, MA (US); Francis Petit DeMange, Stoughton, MA (US)

Correspondence Address: John Christopher, Christopher & Weisberg, P.A., Suite 2040, 200 East Las Olas Boulevard, Fort Lauderdale, FL, 33301, US

(73) Assignee: Ladder Pouch, Inc.

(21) Appl. No.: 10/170,551

(22) Filed: Jun. 12, 2002

(51) Int. Cl. E06C 5/32

(52) U.S. Cl. 182/129

(57) ABSTRACT

A ladder is provided with an integral tool carriage/retention element. The ladder includes a frame, rungs supported by the frame, and an object holder secured to the frame at a selected attachment point on the frame. Multiple attachment points can be provided on the frame. The object holder can include a two-part object retention element that opens and closes to form a loop.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The present invention relates to ladders.

### g BACKGROUND OF THE INVENTION

Climbing aids, such as ladders are well known. However, over the many centuries of their existence, improvements or ladder evolution has been limited. For the most part, present day ladders are strong, yet light, and meet the functional requirement of their users. More particularly, ladders are well suited for scaling heights.

However, ladders do not always serve as good work platforms. For example, ladders do not include storage space for tools or other objects a person may wish to use after having mounted the ladder. For ladders with flat rungs or steps, people often balance objects thereupon with the hope that the object will not fall to the ground. Integral accessory features of ladders that are adapted to hold or support objects are virtually unknown. An example of such an accessory feature or structure is a foldout paint can shelve. These shelves provide larger support surfaces than steps and provide the benefit of not obstructing a step or rung. However, when a ladder must be relocated, objects on even large shelves tend to be easily dislodged.

Tool belts, pouches, buckets, and boxes that are worn or carried by a person substitute or compensate for the lack of integral storage and/or object retention structures on ladder, and are alternatives to balancing objects on horizontal ladder surfaces. Buckets and boxes have utility in holding objects, but they too are often balanced on steps or ladder shelves and therefore can easily become dislodged. Tool pouches that are strapped to a user as a belt can provide much more secure storage than a freestanding tool bucket, but they can encumber their wearer.

A significant improvement over the toolbox or bucket that provides the benefits of the tool belt is a ladder pouch, such as disclosed in U.S. Pat. No. 6,116,419, wherein a tool pouch is secured between the rungs of a ladder to provide vast tools storage in a secure, yet unobtrusive position.

Notwithstanding the advantages provided by the ladder pouch, it would be desirable to have a ladder with integral storage or object retention features that provide the security of a pouch with the ready availability and simplicity of the fold-out paint can tray.

### SUMMARY OF THE INVENTION

The present invention provides a ladder with an integral tool carriage/retention element. In an exemplary embodiment, a ladder includes a frame, rungs supported by the frame, and an object holder secured to the frame at a selected attachment point on the frame. Multiple attachment points can be provided on the frame.

In an exemplary embodiment, the frame includes outwardly facing side portions to which the object holder is secured. Although the object holder can be configured as desired for a specific intended function, the object holder can include a two-part object retention element that opens and closes to form a loop. In an exemplary embodiment, the loop is dimensioned to pass through a center spindle hole of a roll of tape.

### BRIEF DESCRIPTION OF THE DRAWINGS

The foregoing features of this invention, as well as the invention itself, may be more fully understood from the following description of the drawings in which:

FIG. 1 is a perspective view of a ladder in accordance with the present invention showing an object holder in an open state;

FIG. 2 is a is a perspective view of the ladder illustrated in FIG. 1, showing the object holder in a closed state to retain a roll of tape (shown in phantom); and

FIG. 3 is a detail view of the object holder in a closed state to retain a roll of tape (shown in phantom).

### DETAILED DESCRIPTION OF THE INVENTION

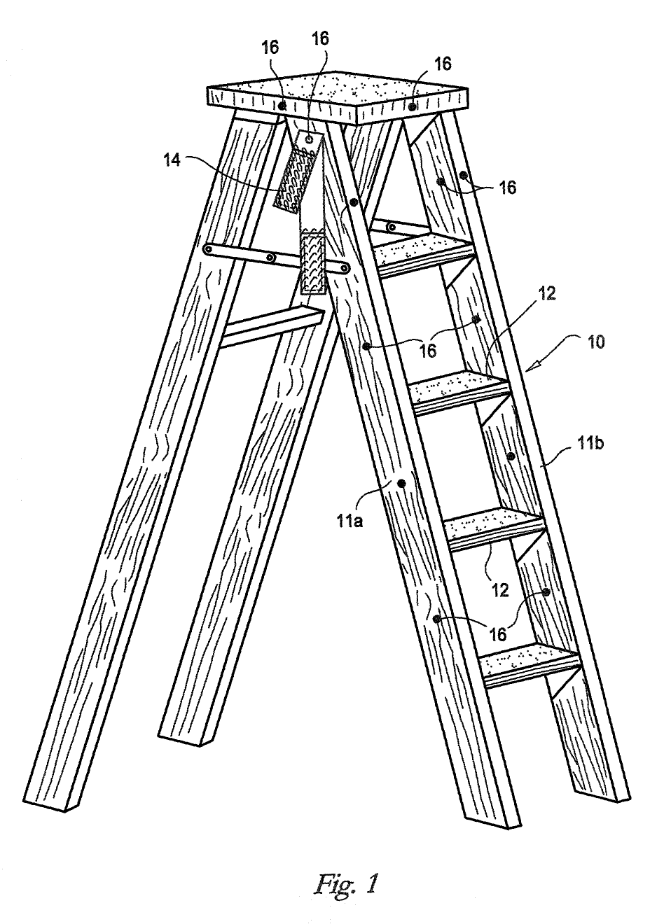

FIG. 1 is a perspective view of a ladder in accordance with the present invention. The ladder includes a frame 10 having outwardly facing sides 11a and inwardly facing sides 11b. Rungs 12 join the inwardly facing sides 11b so as to be supported by the frame 10. Although the sides 11a and 11b are shown as being substantially planar, the sides can be rounded or irregular and still have inwardly and outwardly facing portions.

An object holder/retention device (“object holder”) 14 is secured to the frame at a selected attachment point 16 using a bolt, screw, glue, or other fastening device known in the art. In an exemplary embodiment, the object holder 14 is removably attachable to the frame 10. Multiple attachment points 16 can be provided on the frame 10 to allow one or more object holders to be secured to the frame 10 at one or more locations as desired.

As shown, the object holder 14 is in an “open” or unfastened state, ready to receive an object to be held. Although the ladder shown resembles a traditional wooden folding ladder, with flat horizontal steps or rungs, the specific configuration of the frame 10 and rungs 12 is not important to the invention, nor is the material from which the frame and rungs are made. Thus, the present invention is intended to encompass folding structures, extension or telescopic structures, as well as fixed dimension structures that are made of wood, plastic, metal, fiberglass, and other know materials.

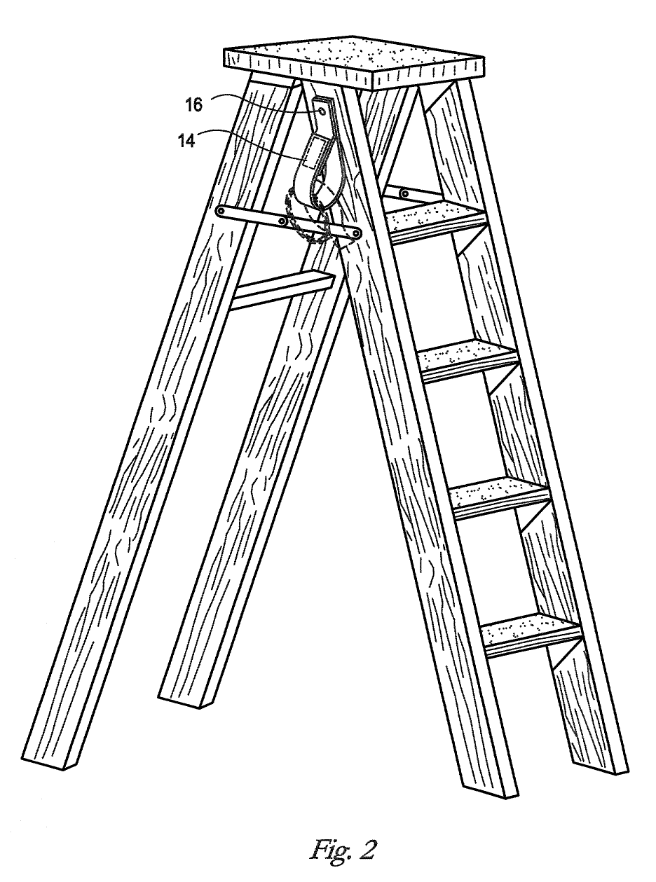

The object holder 14 shown is an elongate, flexible structure having matable engagement structures that allow the object holder to form a loop as shown in FIG. 2. In the illustrated embodiment, the object holder 14 is made of nylon webbing (strap) about an inch and one half in width and provided with hook and pile fasteners. When the hook and pile fasteners are engaged, a generally circular or elliptical loop having a diameter of about five inches is formed. Although a loop is formed that defines a substantially horizontal passage therethrough, the object holder 14 can be configured or positioned to provide a substantially vertical passage theretbrough.

Further, a kit of object holders can be provided, wherein several different object holders each are configured to hold different size and shape objects. Depending upon the object(s) to be secured to the frame 10, a user selects one or more particular object holders and attaches them to the frame for use. Additionally, the kit can include fastening devices that are securable to the ladder, should the ladder not be provided with the same, to engage the object holder and to provide attachment points.

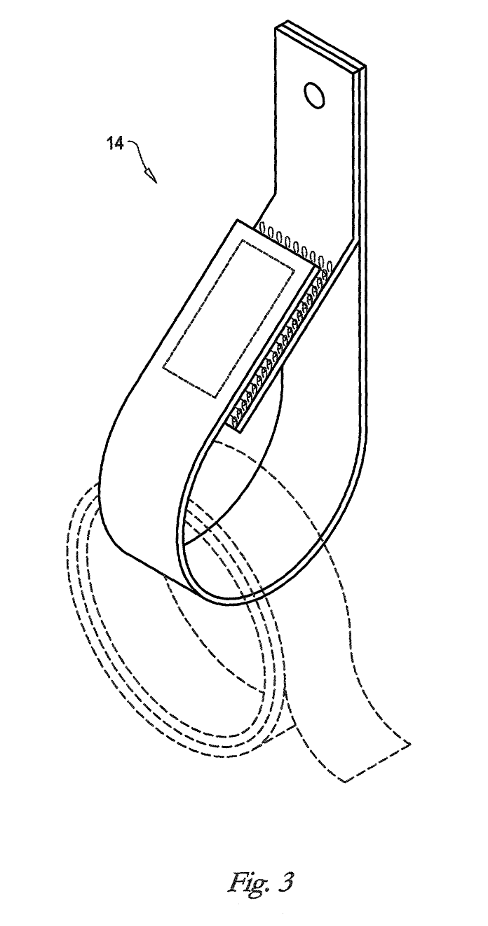

FIG. 2 is a is a perspective view of the ladder illustrated in FIG. 1, showing the object holder 14 in a closed state to retain a roll of tape (shown in phantom). FIG. 3 is a detail view of the object holder in a closed state to retain a roll of tape (shown in phantom). As configured to hold a roll of tape, the roll is free to spin or rotate within while being retained by the object holder 14 to allow tape to be retained by the object holder.

Having described various exemplary embodiments of the invention, it will now become apparent to one of ordinary skill in the art that other embodiments incorporating their concepts may be used. Accordingly, the invention is not to be limited to the particular embodiments described herein, but rather limited only by the spirit and scope of the appended claims. All publications and references cited herein are expressly incorporated herein by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A ladder comprising:
a frame;
a plurality of rungs supported by the frame;
an object holder secured to the frame at a selected attachment point on the frame.

2. The ladder of claim 1, further comprising a plurality of attachment points on the frame.

3. The ladder of claim 1, wherein the frame includes outwardly facing side portions and wherein the object holder is secured to the frame on an outwardly facing side portion.

4. The ladder of claim 3, further comprising a plurality of attachment points on the outwardly facing side portions and wherein the object holder is removably securable to any one of the attachment points.

5. The ladder of claim 1, wherein the object holder defines a loop.

6. The ladder of claim 5, wherein the loop defines a substantially horizontal aperture therethrough.

7. The ladder of claim 5, wherein the loop defines a substantially vertical aperture therethrough.

8. The ladder of claim 5, wherein the loop is flexible.

9. The ladder of claim 8, wherein the loop is made of synthetic fibers.

10. The ladder of claim 1, wherein the object holder is includes a first flexible element matable with a second flexible element to form a unitary element.

11. The ladder of claim 10, wherein the first and second flexible elements are provided with complimentary hook and pile fastener elements.

12. The ladder of claim 1, wherein the object holder is permanently secured to the ladder.

13. The ladder holder of claim 1, wherein the object holder includes a flexible strip of material that is about 1.5 inches wide that can be opened and closed to provide a loop having a substantially horizontal aperture therethrough.

14. A ladder comprising:
a frame including outwardly facing side portions;
a plurality of rungs supported between the outwardly facing side portions;
an object holder secured to the frame on an outwardly facing side portion.

15. The ladder of claim 14, further comprising a plurality of attachment points on the frame, wherein the object holder is removably securable to any one of the attachment points.

16. The ladder holder of claim 14, wherein the object holder includes a flexible strip of material that is about 1.5 inches wide that can be opened and closed to provide a loop having a substantially horizontal aperture therethrough.

17. A ladder comprising:
a frame;
a plurality of rungs supported by the frame;
a plurality of object holder attachment points on the frame;
a plurality of object holders selectively securable to the frame at any of the object holder attachment points.

18. The ladder of claim 14, further comprising a plurality of attachment points on the frame, wherein the object holder is removably securable to any one of the attachment points.
